(19) United States
(12) Patent Application Publication
(10) Pub. No.: US 2010/0257503 A1
(43) Pub. Date: Oct. 7, 2010

(54) POST-ROUTING COUPLING FIXES FOR INTEGRATED CIRCUITS

(75) Inventors: Markus Buehler, Weil im Schoenbuch (DE); Michael A. Kazda, Poughkeepsie, NY (US); Juergen Koehl, Weil im Schoenbuch (DE)

Correspondence Address: CANTOR COLBURN LLP - IBM FISHKILL, 20 Church Street, 22nd Floor, Hartford, CT, 06103, US

(73) Assignee: International Business Machines Corporation, Armonk, NY (US)

(21) Appl. No.: 12/417,136

(22) Filed: Apr. 2, 2009

(51) Int. Cl. G06F 17/50

(52) U.S. Cl. 716/12

(57) ABSTRACT

A method for rerouting a wire in an integrated circuit includes determining a wire coupling a first circuit element to a second circuit element is experiencing capacitive coupling effects with one or more other wires; removing the wire from a netlist; dividing the structure into a routing grid; defining a first and second wire types; associating a penalty with each wire type; determining all possible paths through the routing grid between the first circuit element and the second circuit element; determining a weighted length for each path; and selecting the path having the lowest weighted length.

### BACKGROUND

The present invention relates to integrated circuit design, and more specifically, to detecting and redefining wiring paths in an integrated circuit to reduce coupling effects.

Capacitive coupling is often unintended, such as the capacitance between two wires or PCB traces that are next to each other. Often, one signal can capacitively couple with another and cause what appears to be noise. To reduce coupling, wires or traces are often separated as much as possible, or ground lines or ground planes are run in between signals that might affect each other.

As integrated circuits become more dense, the amount of coupling between adjacent wires will, consequently, increase due to the proximity of the wires. It is, however, difficult to predict the coupling effects before routing. Current approaches to this problem rely on post-routing analysis where an actual routed and analyzed electronically. This is a time consuming process. The discovery of unwanted capacitive effects may lead to two different approaches to removing the coupling. The first involves inserting a buffer into the circuit to reduce the coupling. The second involves rerouting the coupled wires.

The problem with both of these approaches are that there is no wiring optimization during a global engineering change order (EO) routing step which leads to more coupling than is necessary. That is, after the analysis has been done, the new routing may create new coupling.

One prior art approach is disclosed in United States Patent Application US20040098698 which shows a method of searching for a global path between first and second sets of routable elements in a region of a layout. The method partitions the region into several rectangular sub-regions. It then identifies a set of sub-regions that contain the two sets of elements. Next, it performs a path search to identify a set of path expansions between a sub-region that contains a first-set element and a sub-region that contains a second-set element. When the method performs the path search, it explores expansions along non-Manhattan directions between the sub-regions. That prior art focuses on non-rectangular routing but without addressing the problem how coupling could be avoided during global routing.

### SUMMARY

According to one embodiment of the present invention, a method for rerouting a wire in an integrated circuit is provided. The method includes determining a wire coupling a first circuit element to a second circuit element is experiencing capacitive coupling effects with one or more other wires; removing the wire from a netlist describing connections between components of the integrated circuit; dividing the structure into a routing grid, the grid comprising a plurality of routing tiles separated by edges, each edge having a limit of tracks which may cross it; defining a first and second wire types, each wire type having a different width; associating a penalty with each wire type; determining, on a computer, a set of paths through the routing grid between the first circuit element and the second circuit element; determining a weighted length for each path based on the wire type associated penalty for each routing tile crossed by each particular path; and selecting the path having the lowest weighted length and designating that path as a new path.

Another embodiment of the present invention is directed to a computer program product for rerouting a wire in an integrated circuit. The computer program product of this embodiment includes a storage medium readable by a processing circuit and storing instructions for execution by the processing circuit for facilitating a method including: determining a wire coupling a first circuit element to a second circuit element is experiencing capacitive coupling effects with one or more other wires; removing the wire from a netlist describing connections between components of the integrated circuit; dividing the structure into a routing grid, the grid comprising a plurality of routing tiles separated by edges, each edge having a limit of tracks which may cross it; defining a first and second wire types, each wire type having a different width; associating a penalty with each wire type; determining a set of paths through the routing grid between the first circuit element and the second circuit element; determining a weighted length for each path based on the wire type associated penalty for each routing tile crossed by each particular path; and selecting the path having the lowest weighted length and designating that path as a new path.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 shows an example of a prior global routing grid;

FIG. 2 shows a prior routing grid with a detailed routing path displayed thereon;

FIGS. 3a-3c show different possible wire types according to embodiments of the present invention;

FIG. 4 shows two possible wiring path that may be created according an embodiment of the present invention; and

FIG. 5 shows a method of rerouting a wire according to one embodiment of the present invention.

### DETAILED DESCRIPTION

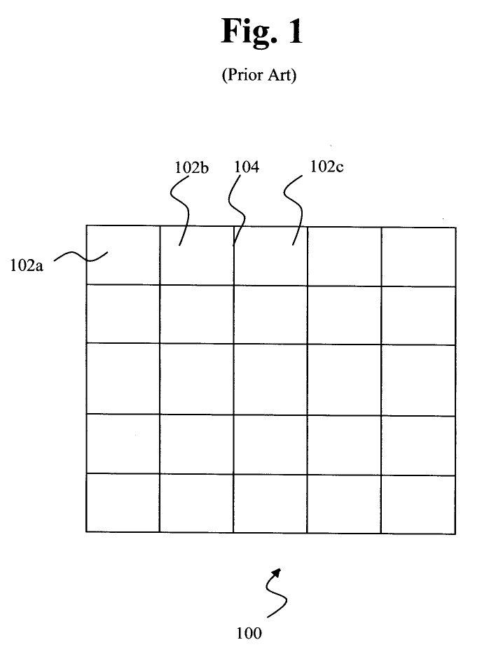

Typically, routing is divided into two to three steps: global routing, track assignment and detailed routing. Some routers drop the middle step. The global router receives a description of the interconnection between circuit elements and determines wire routings. In particular, a global router simplifies routing space by introducing a coarse grid referred to as a global routing grid. FIG. 1 shows an example of a typical global routing grid 100. The grid 100 is divided into global routing tiles 102a, 102b, 102c . . . 102n. In this case, there are 25 routing tiles shown but the number is arbitrary and may be based on the size of the circuit being routed. Each routing tile includes at least one edge that borders another routing tile. For example, the edge 104 of routing tile 102b borders routing tile 102c.

Each edge, in the present invention and in prior art, is defined to have an edge capacity that defines the number of wires that may cross the edge. This number, if exceeded, will prevent the detailed router from successfully route all the wires assigned to this edge. The total number or wires that may actually cross the edge is equal to the capacity minus any tracks that are blocked by circuit structures or existing routing.

Embodiments of the present invention are directed to a global router that determines the path based on certain rules. As discussed below, the global router of the present invention may operate under rules that vary from the prior. In particular, the prior art enforces a rule that minimizes overall wire length while embodiments of the present invention seek to minimize a total weighted wire length.

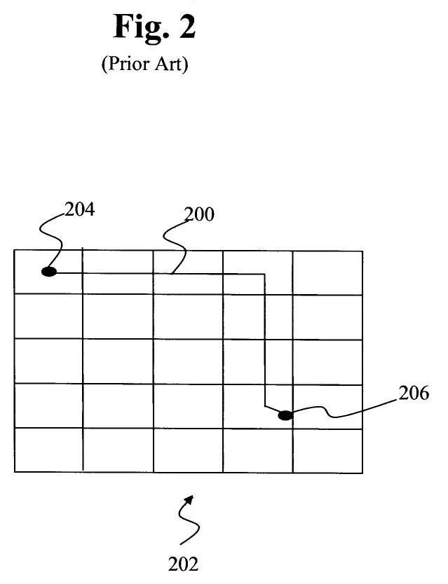

FIG. 2 shows an example of path 200 through a routing grid 202 created utilizing the prior art. In this example, each edge has a “capacity” which defines the number of wires that may cross the edge without overloading it. Overloading of an edge will result in a non-manufacturable chip. The path 200 connects end points 204 and 206. Processing in the global router has ensured that no edge is overloaded in this example.

Most global routers cannot properly handle wide wires: they only measure capacity and wire width without taking into account fragmentation information about empty space between wires. For example, for a wire having a width that is two tracks wide it is not sufficient to have available capacity >=2 on a routing edge, there must be two empty adjacent tracks. A “track” as the term is used herein refers the sum of the minimum width of the wire and the half of the minimum space on either side of the wire (we assume that the other half of the spacing will be contributed by the adjacent wire).

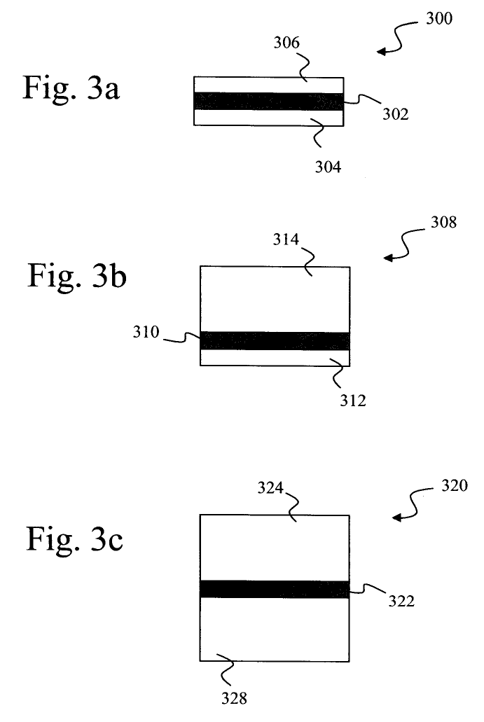

According to embodiments of the present invention, different wire types are defined. The single wire is a defined such that is has a wire width (w) equal to 0.5 tracks. An example of a single wire 300 is shown in FIG. 3a. The region 302 comprises the wire and the regions 304 and 306 represent spacing. The effective width (w_{eff}) of the default wire is equal to 1 track.

FIG. 3b shows an example of a one-side isolated wire 308. The one-side isolated wire includes a region 310 which comprises the wire, a first spacing region 312 which is the same width as the either of the regions 304 or 306 of FIG. 3a, and a region 314 which extends from the wire region 310 such that the total width of the one-side isolated wire 308 has an effective width of 2 tracks.

FIG. 3c shows an example of a two-side isolated wire 320. The two-side isolated wire 320 includes a wire region 322 and spacing regions 324 and 326. The spacing regions 324 and 326 are of equal width and when added together and to the wire region 322 result in a two-side isolated wire having an effective width of 3 tracks.

It should be note that the wire types shown in FIGS. 3a-3c are by way of example only. Fully gridded routers may only support these wire types. In one embodiment, a more advanced router that does not rely on a routing grid may support addition spacing types so long as each wire has a width and is surrounded by a spacing region on each side.

In one embodiment, during global routing, each wire type is assigned a different “penalty.” In one embodiment, the penalty is inversely proportional to the width of the wire. For example, in one embodiment, p(2s-isolated)=p2, p(1s-isolated)=p1, and p(single)=ps, where p2<p1<ps.

In addition, the optimization goal of global router may be changed according to embodiments of the present invention. In particular, instead of minimizing total wiring length L as in the prior art, a global router according to embodiments of the present invention seeks to minimize the total weighted wiring length L_{w}. As shown in greater detail below, the weighted wiring length, based on the penalties, causes paths that allow for “wider” wires to be placed being favored over those that require narrower wires to be placed. The wider wires, as shown above, allow for larger separation of wires, thus, reducing capacitive coupling.

In greater detail, the total weight wiring length L_{w} is equal to the sum of all weighted lengths lₙ. For all tiles that a path passes through, lₙ for a particular tile length of the tile (l) (which, in some embodiments is always equal to 1) is the product of the length times the penalty for the largest type wire that may be placed. This weighting, may, in some embodiments, result in a longer path being taken than is necessary but that path has a lower weighted length. The lower the weighted length, the less likely that capacitive coupling may occur.

State in terms of mathematical formulas, the above description may be represented as:

L_{w}=Σl₁(x,y,z)*pₙ(x,y,z,)

where (x,y,z) represents global routing tile with horizontal coordinate x, vertical coordinate y and layer z, lₙ(x,y,z) is the length the tile in global routing tile (x,y,z) and pₙ(x,y,z) is the penalty associated with the particular wire type that may be placed. The penalty as described above, is equal to ps, p1, or p2. In some instances, the product of lₙ(x,y,z) and pn(x,y,z,) may be referred to herein as a tile cost.

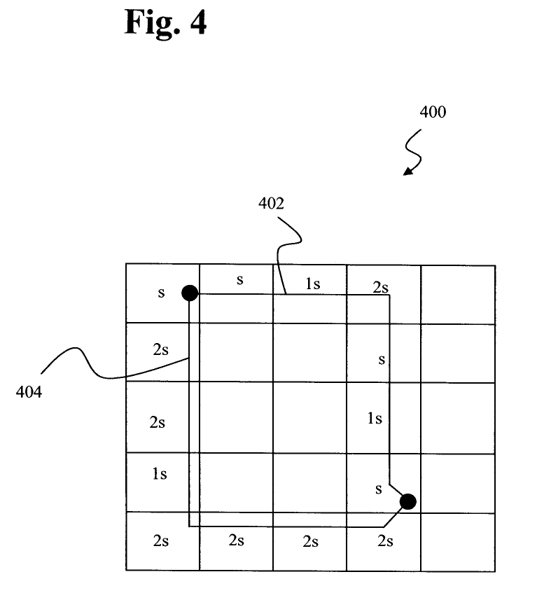

Minimizing the weighted length will guide the global router to make a limited detour before switching to a wiretype with less spacing, thus minimizing the overall coupling capacitance. FIG. 4 shows two possible paths 402 and 404 through a routing grid 400. In this example, ps=3, p1=2 and p2=1. Again, the global router will always attempt to place the widest possible wire it can. Of course, the present invention may assume that prior routing has been performed and all other wires, except the one being rerouted, have been placed. Thus, the available space in each grid tile is known before the routing begins.

In FIG. 4, each traversed tile includes an indication of the widest wire that may be placed therein. Applying the above formula to each path with the penalties described above (and assuming the length of each tile as 1), results in path 402 having a value of L_{w} equal to 18 and path 404 having a value of L_{w} equal to 14. According to embodiments of the present, the global router would choose path 404 even though it is longer because the value of L_{w} for path 404 is less than for path 402.

Proposed penalty values were disclosed above by way of example only. In another embodiment, the penalties may reflect the wiring capacitances per unit length. As such, if the coupling of a single wire with neighbors as close as possible is cs, the coupling with a 1s-isolated wire with neighbors as close as possible is c1, and the coupling with a 2s-isolated wire with neighbors as close as possible is c2 then, p2=1, p1=c1/c2, and ps=cs/c2.

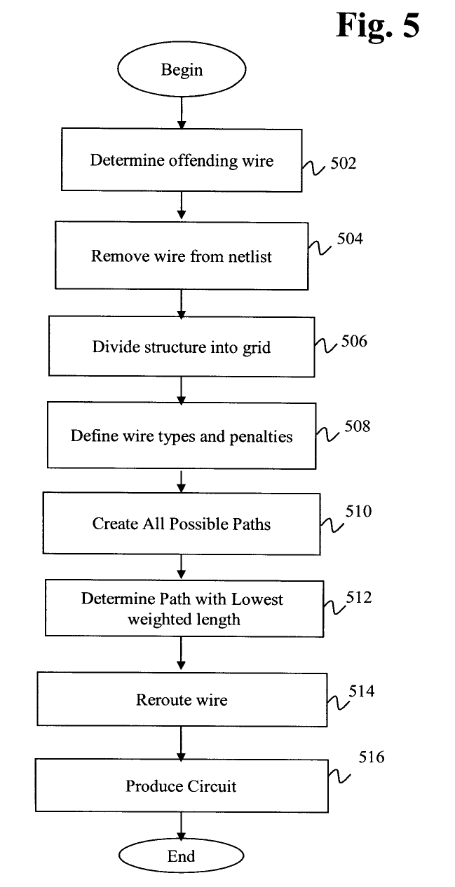

FIG. 5 shows an example of a method of rerouting of a wire according to one embodiment of the present invention. At a block 502 one or more wires that are experiencing coupling affects are identified. Computer analysis or physical testing of a completed integrated circuit may achieve the determination of wires exhibit capacitive coupling. Of course, other methods may be used to determine that one or more wires are exhibiting capacitive coupling. It will be understood that before fabrication and testing, a net list describing the connections between the various components is typically created. The connections and routings of the wires are defined in this net list. As such, a net list, at this stage also called layout, contains the final routing information for each wire.

Regardless of how particular wires exhibiting capacitive coupling are identified, in one embodiment, at a block 504 the one or more identified wires are removed from a net list that defines the connections between elements in a circuit. The removal of the wire is required in order for an accurate determination of the possible paths for the re-routing of the identified wire.

At a block 506 the structure is divided into a routing grid. The routing grid may be two or three dimensional in some embodiments. At this stage the connections and the number of traces crossing tile boundaries of the routing grid are already known. Of course, the number of traces does not include the identified wire as it has already been removed.

At a block 508 wire types and penalties are defined. As discussed above, there may be three or even more types of wires. Each wire type includes a penalty associated there with. Examples of such penalties are described above as way of example only and other penalties may be implemented. In summary, the wider the wire, the lower the penalty. This may help to cause longer paths with lower coupling to be selected.

At a block 510 all possible paths for the wire or a relevant subset thereof are determined. In one embodiment this may be conducted on a computer.

At a block 512 the path having the lowest weighted length is selected. The determination of the weighted link of each path is described in greater detail above.

At a block 514 the wire is detail-rerouted. This may include, for example, updating the net list for the circuit to indicate that the particular wire is going to be routed along the path determined at block 512. At a block 516 a circuit based on the net list is produced. This circuit has the revised wire routing in it. Between rerouting the wire and producing the chip there maybe other steps like rerouting other wires, other transforms, sign off checking etc.

It will be understood that embodiments of the present invention may be implemented on a computing device including, but not limited to, a personal computer or a network of computers. As described above, the embodiments of the invention may be embodied in the form of computer-implemented processes and apparatuses for practicing those processes. Embodiments of the invention may also be embodied in the form of computer program codes containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one ore more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for rerouting a wire in an integrated circuit, the method comprising:
determining a wire coupling a first circuit element to a second circuit element is experiencing capacitive coupling effects with one or more other wires;
removing the wire from a netlist describing connections between components of the integrated circuit;
dividing the structure into a routing grid, the grid comprising a plurality of routing tiles separated by edges, each edge having a limit of tracks which may cross it;
defining first and second wire types, each wire type having a different width;
associating a penalty with each wire type;
determining, on a computer, a set of paths through the routing grid between the first circuit element and the second circuit element;
determining a weighted length for each path based on the wire type associated penalty for each routing tile crossed by each particular path; and
selecting the path having the lowest weighted length and designating that path as a new path.

2. The method of claim 1, wherein each wire type contains a wire portion and two spacing portions, each spacing portion being on an opposite of the wire portion, and wherein the wire portion and the spacing portions collectively define the width of the wire type.

3. The method of claim 2, wherein the width of the first wire type is one track and the width of the second wire type is two tracks.

4. The method of claim 3, further comprising:
defining a third wire type of a third width that is equal to three tracks.

5. The method of claim 3, wherein determining all possible paths includes creating only paths no edge exceeds its track limit.

6. The method of claim 5, wherein determining all possible paths includes crossing an edge with the a wire type having the largest number of tracks that does not exceed the track limit.

7. The method of claim 1, wherein the penalty associated with the first wire type is greater than the penalty associated with the second wire type and the penalty associated with the second wire type is greater than the penalty associated with the third wire type.

8. The method of claim 1, wherein determining the weighted length includes:
for each tile crossed by the path, multiplying the length of tile by the penalty associated with the wire type crossing the path to create a tile cost for each tile; and
summing the tile cost for each tile crossed by the path.

9. The method of claim 1, further comprising:
rerouting the wire, rerouting including storing the new path in a the netlist.

10. The method of claim 1, further comprising:
creating the integrated circuit.

11. A computer program product for rerouting a wire in an integrated circuit, the computer program product comprising:
a storage medium readable by a processing circuit and storing instructions for execution by the processing circuit for facilitating a method including:
determining a wire coupling a first circuit element to a second circuit element is experiencing capacitive coupling effects with one or more other wires;
removing the wire from a netlist describing connections between components of the integrated circuit;
dividing the structure into a routing grid, the grid comprising a plurality of routing tiles separated by edges, each edge having a limit of tracks which may cross it;
defining a first and second wire types, each wire type having a different width;
associating a penalty with each wire type;
determining a set of paths through the routing grid between the first circuit element and the second circuit element;
determining a weighted length for each path based on the wire type associated penalty for each routing tile crossed by each particular path; and
selecting the path having the lowest weighted length and designating that path as a new path.

12. The computer program product of claim 11, wherein each wire type contains a wire portion and two spacing portions, each spacing portion being on an opposite of the wire portion, and wherein the wire portion and the spacing portions collectively define the width of the wire type.

13. The computer program product of claim 11, wherein the width of the first wire type is one track and the width of the second wire type is two tracks.

14. The computer program product of claim 13, wherein the method further comprises:
defining a third wire type having a width of three tracks.

15. The computer program product of claim 13, wherein determining all possible paths includes creating only paths no edge exceeds its track limit.

16. The computer program product of claim 13, wherein determining all possible paths includes crossing an edge with a wire type having the largest number of tracks that does not exceed the track limit.

17. The computer program product of claim 11, wherein the penalty associated with the first wire type is greater than the penalty associated with the second wire type and the penalty associated with the second wire type is greater than the penalty associated with the third wire type.

18. The computer program product of claim 11, wherein determining the weighted length includes:
for each tile crossed by the path, multiplying the length of tile by the penalty associated with the wire type crossing the path to create a tile cost for each tile; and
summing the tile cost for each tile crossed by the path.

19. The computer program product of claim 11, wherein the method further includes:
rerouting the wire, rerouting including storing the new path in a the netlist.
